(19) United States
(12) Patent Application Publication
(10) Pub. No.: US 2006/0065546 A1
(43) Pub. Date: Mar. 30, 2006

(54) Electric discharge machining electrode and method

(76) Inventor: Alain Curodeau, Sainte-Foy (CA)

Correspondence Address: QUARLES & BRADY LLP, 411 E. WISCONSIN AVENUE, SUITE 2040, MILWAUKEE, WI, 53202-4497, US

(21) Appl. No.: 10/495,777

(22) PCT Filed: Nov. 19, 2002
(86) PCT No.: PCT/CA02/01787

§ 371 Date: Mar. 16, 2005

Related U.S. Application Data
(60) Provisional application No. 60/331,549, filed on Nov. 19, 2001.

(51) Int. Cl. B23H 9/00

(52) U.S. Cl. 205/640

(57) ABSTRACT

A method for electric discharge machining (EDM) with a ductile carbonaceous electrode, to automate roughing, finishing, polishing and texturing operations on a electrically conductive material. The EDM method comprises using a ductile electrically conductive electrode made of carbon-polymer composite material. Prior to electric discharge machining, the electrode is made by heating uniformly a prescribed volume of said ductile electrode material, at a temperature close to the melting point temperature of the polymer matrix. The composite material is then molded into the desired electrode shape by pressing the soft material against a template, a mold model, a replicate of the workpiece or part of the workpiece. The formed electrode is then used to machine the desired shape and surface finish on the said workpiece using proper electric discharge machining techniques. When the dimensions and surface of the electrode are altered by wear, the same electrode can be rectified quickly and repetitively, by following the initial procedure of softening and pressing until the workpiece is complete.

### FIELD OF THE INVENTION

The present invention relates to finishing, polishing and texturing methods. More specifically, the present invention concerns electric discharge machining electrode and method.

### BACKGROUND OF THE INVENTION

As is well known in the art, Electrical Discharge Machining (EDM) allows removal of metal from a workpiece by the energy of an electric spark that arcs between a tool and a surface of the workpiece, both the tool and the workpiece being immersed in a dielectric fluid. Rapid pulses of electricity are delivered to the tool, causing sparks to jump between the tool and the workpiece. The heat from each spark melts away a small amount of metal from the workpiece. As the metal is thus removed, it is cooled and flushed away by the dielectric fluid being circulated through a spark gap. A surface finish achieved is inversely proportional to a frequency of electrical discharges, a height of final rugosities is inversely proportional to a number of electrical discharges (cycles) per second.

The dielectric fluid not only provides insulation against premature discharging but also cools down a machined area of the workpiece and allows to flush away metallic and non-metallic EDM spark debris.

Generally, the workpiece material wears away 10 to 100 times faster than the tool material, depending on a melting point of the workpiece and tool material respectively, so that the lower the melting point, the higher the wear rate. The tool for EDM is usually an electrode made of graphite, although brass, copper, or copper-tungsten alloy are also used. With a sublimation temperature of 3300° C., graphite electrodes have the highest wear resistance. Usually, several electrodes are needed to achieve a precise carving of a single workpiece, due to electrode wear.

EDM with a graphite electrode proves to be advantageous for machining intricate shapes with precision on mold and die cavities in hard tool steel. Since the EDM removal rate is slow, the bulk of the material is usually first removed by conventional machining, such as by milling and turning, while finishing and polishing are performed either by EDM or manually.

Various methods are used to make graphite EDM electrodes, such as high-speed milling, turning, rapid prototyping, for example. However, current methods of making electrodes are generally time consuming and costly.

Moreover, finishing operations commonly involve a significant amount of manual work, which can range from 5 to 40% of the total metal tooling cost, depending on a required texture or finish, as established by a final application, in terms of a required degree of luster on a given part or section of a part of the workpiece. For example, the surface finish may be required to be as rough as 0.8 μm RMS (or 30 micro inch RMS, RMS standing for “Root Mean Square” geometric accuracy) or to have a mirror finish at 0.02 μm RMS (or 1 micro inch RMS). Since conventional machining methods yield, at best, a surface finish in the range comprised between 0.8 and 3.2 μm RMS (or 30 to 100 micro inch RMS), in most cases finishing operations are further required.

Recently, in the mold industry, tooling has been produced using rapid prototyping technologies such as stereolythography, selective laser sintering etc. Even though such technologies provide significant advantages in terms of fabrication flexibility and lead-time, they are still limited by a poor surface finish performance of about 12 μm RMS (500 micro inch RMS) in a best case scenario.

Therefore, there is a need in the art for improved EDM electrode and method.

### OBJECT OF THE INVENTION

An object of the present invention is therefore to provide EDM electrode and method that mitigate the drawbacks of the prior art.

### SUMMARY OF THE INVENTION

More specifically, in accordance with the present invention, there is provided an EDM electrode comprising a carbonaceous solid material and a matrix material, wherein the carbonaceous solid material has a content of carbon black of 35% wt or less.

Furthermore, there is provided a method for fabricating an EDM electrode comprising providing a carbonaceous material; and selecting a matrix material; wherein providing graphite and carbon black comprises providing graphite and carbon black with a proportion of carbon black of 35% wt or less.

There is further provided an EDM method for finishing a workpiece comprising providing a replica of the workpiece; providing a generic electrode; shaping the generic electrode into a matching electrode using the replica as a mold; and performing EDM on the workpiece with the matching electrode.

There is further provided an EDM method for finishing operations on a workpiece comprising providing a replica of the workpiece; and molding a ductile electrode in the replica of the workpiece.

There is also provided a method for reworking a ductile electrode used to EDM a workpiece, by forming the ductile electrode in a replica of the workpiece comprising:

preheating the replica in the vicinity of a melting point temperature of a polymer matrix of the ductile electrode;

feeding a single piece of material with roughly a same geometry as the replica into the pre-heated replica;

closing the replica by means of a tight cover;

compressing the content of the closed replica;

shaping the electrode inside the replica;

cooling down the replica and allowing the electrode to solidify;

wherein the shaping the electrode inside the replica comprises creating a isostatic pressure inside the replica and maintaining the isostatic pressure to allow a uniform temperature distribution throughout the polymer composite and to yield a reshaped electrode.

There is further provided an EDM method for finishing operations a milled metal cavity comprising forming, in the milled metal cavity used as a mold, a negative replicate of the milled metal cavity into an electrode; and EDM the milled metal cavity with the electrode; whereby the electrode comprises micro-peeks and valleys patterns of the milled metal cavity, thus representing a negative of the milled metal cavity in such a way that the micro-groove valleys of the milled metal cavity become micro-peeks of the electrode and are used to level the milled metal cavity surface by spark erosion.

There is further provided an EDM method for finishing operation on a milled metal cavity using the pre-milled cavity as a mold to form a negative replicate of the cavity onto a ductile electrode that results as a negative of the milled metal cavity so that micro-groove valleys of the milled metal cavity become micro-peeks of the electrode that level the milled metal cavity surface by spark erosion and, once a prescribed fraction of the cavity surface roughness is flattened and a new, smoother, cavity surface is obtained, the electrode is reprocessed in the new, smoother, cavity in order to match the surface thereof with the new, smoother, cavity surface.

There is further provided a method for molding a composite carbonaceous material into a generic electrode of simple geometric shape held around a metallic insert holder wherein a ductile electrode material is softened to yield a softened electrode, which is then pressed against a mold in order to be given a final shape and surface finish.

There is finally provided a use of a ductile carbonaceous-metal polymer composite material as an EDM electrode to perform EDM of electrically conductive material.

Other objects, advantages and features of the present invention will become more apparent upon reading the following non restrictive description of specific embodiments thereof, given by way of example only with reference to the accompanying drawings.

### BRIEF DESCRIPTION OF THE DRAWINGS

In the appended drawings:

FIG. 1 is flowchart of a method according to an embodiment of a first aspect of the present invention;

FIG. 2 is flowchart of a method using an electrode fabricated following the method of FIG. 1, according to one embodiment of a second aspect of the present invention;

FIG. 3 is an illustration of the method of FIG. 2;

FIG. 4 is flowchart of an EDM method according to another embodiment of the second aspect of the present invention; and

FIG. 5 is a plot of a reduction of surface roughness by an iterative EDM method according to the present invention.

### DESCRIPTION OF SPECIFIC EMBODIMENTS

Generally stated, the present invention aims at reducing EDM operating costs 1) by providing ductile electrodes that may be fabricated at an improved rate of production and 2) by providing a method using these ductile electrodes for roughing, finishing and polishing and texturing operations.

According to a first aspect of the present invention, there is provided a ductile electrode and a method of fabrication thereof.

The ductile electrode of the present invention is generally made in a ductile carbonaceous material prepared by combining an adequate proportion of carbonaceous and/or metallic powder within a thermoplastic polymer or wax matrix. The amount of solid carbonaceous is optimized to yield a material combining required properties of ductility and electric conductivity, and, simultaneously, properties of formability.

The main ingredients of the EDM ductile electrode are carbon and graphite because of their inherent resistance to high temperature and basic electrical conductivity. Carbon and graphite are both pure C elements, but graphite, due to a particular crystalline structure, is about 100% less resistive than carbon black (0.12 ohm×cm). Although a better conductor, graphite proves to be less effective in turning a polymer matrix conductive, whereas carbon black easily makes a polymer matrix conductive

Optimization of the material composition for the EDM electrode involves achieving a balance between a proportion of solid additives having a carbon structure and solid additives having a graphite structure, and also, between solid additives of varying topologies. Indeed, on the one hand, solid additives of a graphite structure have a negative effect on the formability of the resulting material, contrary to those of a carbon structure: therefore black carbon is found to be advantageous in this regard. On the other hand, topologies such as fibers or whiskers are to be avoided since they tend to decrease the formability of the resulting material, and also because they do not allow fine surface finish: in this regard, powders and nanotubes, which are micro-fibers, are advantageous. In both respects, carbon black is found advantageous, since it increases the electric conductivity, as well as the formability, of the resulting material.

Experimental results have shown that an amount of solid material comprised in the range between 40 and 75% yields a good ductility of the material in a molten state thereof. Within this range, it is further shown than an adequate conductivity is achieved by adding carbon black powder in a proportion varying between 5 and 20% by weight.

Several types of carbon black are commercially available, such as furnace black, channel black, thermal black and acetylene black, among which the furnace black type has a higher electrical conductivity. Indeed, due to a larger surface area and volume loading per unit weight, the furnace black powder has a higher tendency to create aggregate-to-aggregate electrical contacts, which is known as making a polymer conduct electricity. Indeed, it was found that powder, flake and fiber particles interaction is a significant factor that influences electrical conductivity in a carbon-polymer composite.

Recent developments have also shown that carbon nanotubes, due to a hollow filiform structure thereof, may further enhance electrical conductivity of a polymer-based electrode. It has also been found that a smaller particle size is more efficient to generate a good EDM surface finish. Finally, the thermal conductivity has been shown to be a factor to consider in order to efficiently remove heat from the electrode. In this regard for example, graphite material (600 W/mK) is approximately 600% better thermal conductor than carbon black (1 W/mK) and 3000% better than polystyrene (0.2-0.3 W/mK). Carbon black further contributes to improve the formation of composite polymer materials. Furthermore, experiments on carbon-polymer compositions, including amounts of carbon black of about 10% by wt have produced a much lower torque on a mixing screw.

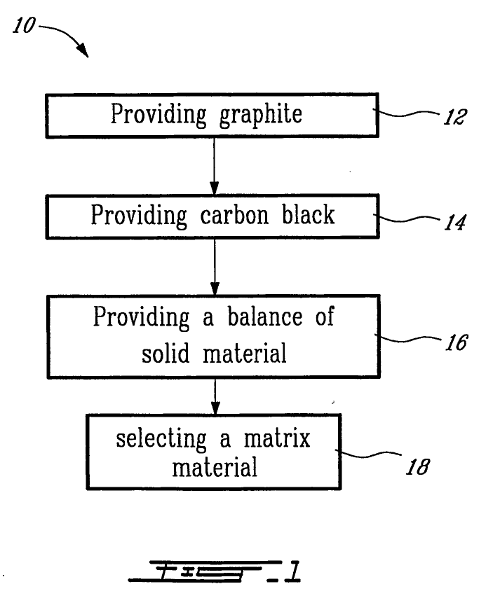

As illustrated in the flowchart of FIG. 1, a method 10 for fabrication of such an electrode comprises providing graphite (step 12); providing carbon black (step 14); providing a balance of solid material (step 16); selecting a matrix material (step 18)

In steps 12 and 14, the content of graphite is optimized so that carbon black is added in a proportion of 35% wt or less.

In step 16, the balance of solid material is provided so as to minimize the proportion of graphitized material of topologies such as flakes and whiskers for example, which, although they are found to favor the creation of a daisy chain of electrical contacts between adjacent particles and to thus yield an electrically conductive polymer composite, unfortunately, as mentioned hereinabove, decrease the formability of the resulting material and do not allow to achieve fine surface finish. The mesh of the graphite powder may be in the range of 100 to 350 mesh depending on a desired surface finish on the ductile electrode and workpiece. Smaller solid particles are found to be more suited to the EDM finishing operation while larger and random-shaped solid particles are found to yield a higher conductivity per weight of additive.

The balance of solid material therefore comprises an amount of graphite flakes of at most 20% by weight, a minimized amount of graphite whiskers (less than 5% by weight), and a maximized amount of graphite powder (up to 50% by weight). Metal powder, such as copper powder for example, may also be added in a proportion in the range from 1 to 20% wt as an alternative to graphite flakes, whiskers and powder, to increase the thermal conductivity of the composite polymer. Single and multiple walls carbon nanotubes may be added in a proportion varying between 1 and 10% by weight to provide desired electrical and thermal properties to the composite material.

In step 18, the matrix material may be a thermoplastic polymer, such as polystyrene, polyethylene, polypropylene, polyamide-imide, PEEK, or a wax, such as paraffin or bees wax, since experimental results have shown that a number of thermoplastic polymer or wax can be made conductive providing the use of prescribed carbonaceous additives. However, some thermoplastic polymers, such as polyimides (PI), offer a high wear resistance and dimensional stability, which are characteristics suitable to the EDM process due to a greater resistance to high temperatures and low moisture absorption they involve

The polymer content may be minimized to optimize electrical and thermal conductivity. The thermoplastic polymer is selected according to a number of factors, including mainly rigidity, low water absorption and thermal resistance, to provide dimensional stability in water and resistance to thermal wear. Although advanced thermoplastic polymer families such as PI and polyetheretherketones (PEEK) can be used, such polymers are relatively expensive, especially considering the amount of material that is needed to initiate the electrode material development. Therefore, polystyrene polymers prove to be a good compromise between cost, availability and required properties.

Obviously, the proportion of additives (step 16) may vary depending on the matrix material selected in step 18.

People in the art will appreciate that the method of this first aspect of the present invention provides an EDM electrode combining a low electrical resistivity, a high thermal conductivity, a good formability, a good dimensional stability in water, a low coefficient of thermal expansion and a high resistance to thermal cycling.

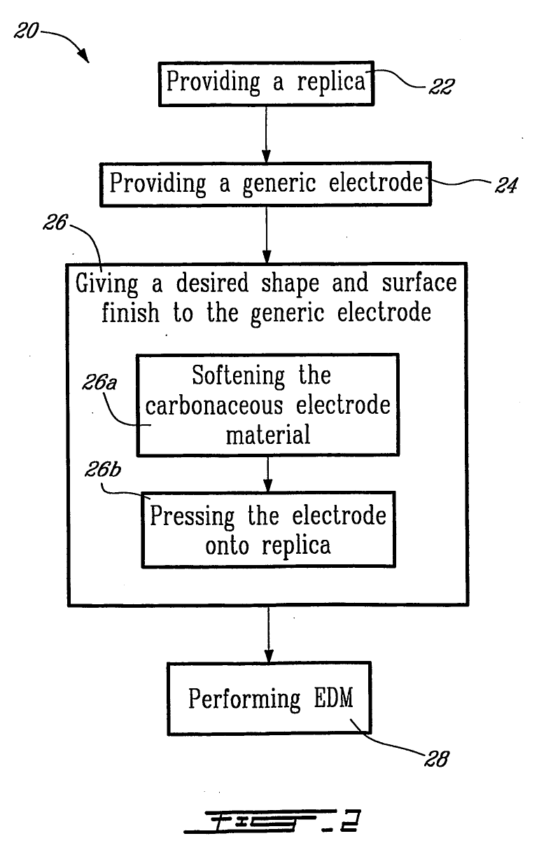

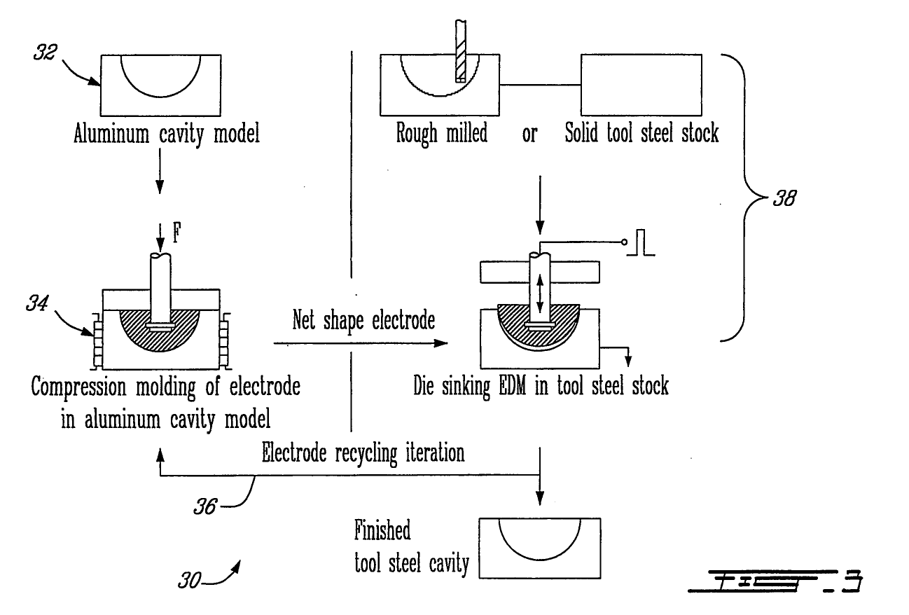

Turning now to a second aspect of the present invention, an EDM method according to a first embodiment will now be described in relation to FIGS. 2 and 3 of the appended drawings. Since the method uses a replica as a mold to fabricate, by pressing, compression molding, blow molding or casting, a matching EDM electrode, it will hereinafter be referred to as the “replica EDM method” 20.

The replica EDM method 20 generally comprises providing a replica (step 22); providing a generic electrode (step 24); giving a desired shape, surface finish and texture to the generic electrode (step 26); and performing EDM (step 28).

The replica (also called sometimes a “model” or a “template”) provided in step 22 may be a simple template having either a flat, curved, smooth or textured surface with a predetermined geometry. It may be designed as a single part or as a plurality of interlocking mold parts made out of almost any material, with a preference for good thermal conductors.

The generic electrode provided in step 24 may be a cylinder, a cone, a sphere, an ellipsoid, a cube or any simple geometric shape of desired dimension. It may be made by injection molding a prescribed electrode material around a metallic insert used as an electrode holder. Such generic electrodes may be made in a series so that a plurality of such electrodes are stored close to an EDM machine.

In the following step 26, the generic electrode is given a desired shape and surface finish, by first softening the carbonaceous electrode material by induction, conduction or radiant heating (substep 26a). Then, when a required softening temperature of the electrode material is reached, the electrode, still held by the metallic insert, is pressed onto the replica of the desired part (substep 26b). As the electrode material is pressed against the replica, the electrode material cools down and solidifies by heat transfer, resulting in the desired shape and surface finish.

Alternatively, the pressing action (substep 26b) may be conducted by a robot arm or a CNC (Computer Numerical Control) machine-tool, which can carve a complex electrode shape and surface by moving the softened electrode material relative to the replica (or vice versa) along 3D trajectories.

The pressing action (substep 26b) may further be performed by applying pressure inside a preheated hollow ductile electrode confined inside a two-part or multiple part mold, by forcing gas through a bored electrode holder insert onto which the hollow ductile electrode is affixed. The softened electrode material inflates under the gas pressure until conforming to the shape and surface finish of the part of the mold, then cooling down and solidifying into the desired shape. Cooling passages may be provided within the parts of the mold in order to increase the solidification rate.

Once the electrode has the desired shape, EDM is performed in a dielectric fluid, such as deionized water, mineral oil or gas (i.e. air) for example, either by simple plunging, orbital plunging or with a stylus machining method (step 28). Electrical impulse parameters may be so determined to minimize the wear of the electrode, in particular by adequately adjusting an impulse timing (ON and OFF time), a maximum current and a polarity thereof. It is believed to be within the reach of a person skilled in the art to determine, from experience, which control parameters reduce the wear rate of the electrode.

The above-described replica EDM method 20 may be applied as illustrated in FIG. 3. In the example illustrated in FIG. 3, an aluminum replica is provided (step 32) as a mold in which a ductile electrode is then formed, here by compression molding (steps 34 and 36).

More precisely, the aluminum replica is preheated in the vicinity of a melting point temperature of the electrode polymer matrix, for example to a temperature comprised between 200° C. and 210° C. in the case of a polystyrene matrix. Pellets of composite material are then fed into the pre-heated replica before the replica is closed tight by means of a tight cover for example. An electrode holder, which acts as a piston, is inserted in a precision circular opening provided into the tight cover to compress the porous mixture herein and to remove any voids around the pellets. Then a vertical force is applied on the electrode holder to build an isostatic pressure inside the replica. This pressure is maintained long enough to allow a uniform temperature distribution throughout the polymer composite, thereby allowing to obtain a generic electrode having enhanced surface details and a minimum amount of porosity. After such a prescribed period of time, which mainly depends of the part cross-section, the replica is cooled down while still maintaining the molding pressure. Once the electrode is solidified, it is ready for EDM operation on a workpiece to be finished (step 38).

Although other dielectric fluids may be used in the EDM step (steps 28 and 38), the use of water or of a gas such as air as a dielectric fluid is particularly safe for the environment since these can be easily recycled or disposed of.

Moreover it has been found that water allows an improved controllability of the finishing operation and of the dielectric strength, through the use of a water dielectric fluid system to control the dielectric strength and flushing pressure of the water. Such a dielectric fluid system may be further designed to automatically control the dielectric strength of the water, to filtrate steel and graphite residues and to control the flushing pressure.

Finally, the dielectric rigidity of water may be adjusted according to a desired degree of material removal, whether it is for coarse, fine, very fine or mirror finish operations. A higher dielectric rigidity is, often related to a higher metal removal rate and vice versa. While water is rarely or never used for die sinking EDM in the methods described in the prior art, since better material removal rate can be achieved with mineral oil, a method according to the present invention allows finishing operations at a lower current level for which water is very efficient. In addition, since water viscosity is lower than that of a mineral oil, flushing may be achieved more efficiently, especially when a very small electrode gap is used, as in the case of mirror finishing.

Interestingly, the replica EDM method may be used to rebuild a worn out electrode surface. Indeed, the ductile electrode described in the first aspect of the present invention, happens to been worn out during EDM operations, but it is herein shown that it may recover its initial shape by repeating the compression molding steps (step 36), with the difference that a single piece of material with roughly a same geometry as the replica is fed into the replica, instead of pellets of material. The worn out electrode may be pre-heated by radiant heaters in order to soften an outside surface thereof. If several molding cycles are needed on a same electrode, cautions should be taken not to exceed a specified mold temperature so as to delay the polymer matrix degradation, and the range of molding pressure is to be established so that the molding pressure is not high enough to break an electrical network originating the electrode electrical conductivity on the one hand, and higher than a minimum pressure needed to create and maintain this electrical network.

On the one hand, since the ductile electrode of the first aspect of the present invention has a lower content of carbonaceous solid than a conventional solid graphite electrode, it is expected to wear out faster than the latter. However, on the other hand, since, in a second aspect thereof, the present invention provides a method for ductile electrode rework that does not involve any milling or turning operations, unlike standard electrode material, it is most efficient and allows a reduction of the overall EDM cost for a given quality of work.

Therefore, when, after a period of EDM on the desired workpiece, an electrode no longer meets prescribed tolerances, it may be recycled into a new one by reprocessing it through the initial molding cycle (see FIGS. 2 and 3) of the replica EDM method, which may be repeated to quickly and efficiently fabricate several identical composite electrodes, as long as the desired dimensions and surface finish of the tool steel workpiece are not achieved. People in the art will appreciate that, in sharp contrast, the fabrication process of standard solid graphite or copper electrode is much slower.

Alternatively, the replica EDM method may be considered for only a section of a replica when a geometric detail, such as a sharp edge, a smooth fillet, a complex geometry or surface texture, is locally needed in a region of the replica. For such localized operations, a bank of standard geometric replicas including for example corners, deep grooves, 90° edges, 90° fillets with various radius, and textured surfaces, may be fabricated and used for recurrent geometric details.

Obviously, since a replica is needed in the first place (see step 22 FIG. 2), the EDM replica method proves to be most useful in the case where several identical electrodes are required. As a matter of fact, it is a common practice in the mold industry to use several electrodes, or at least two, for a rough and a fine finish respectively, to fabricate a single cavity tool steel mold. Even more than two electrodes are used in the case of multiple cavity molds.

Interestingly, unlike standard solid graphite or copper electrodes, the ductile polymer-carbon electrode material of the present invention may be repeatedly softened and molded to the desired geometry with fine dimensional tolerance and surface finish. Thus, as people in the art will appreciate, high quality molded electrodes may be produced much faster than with standard milling methods.

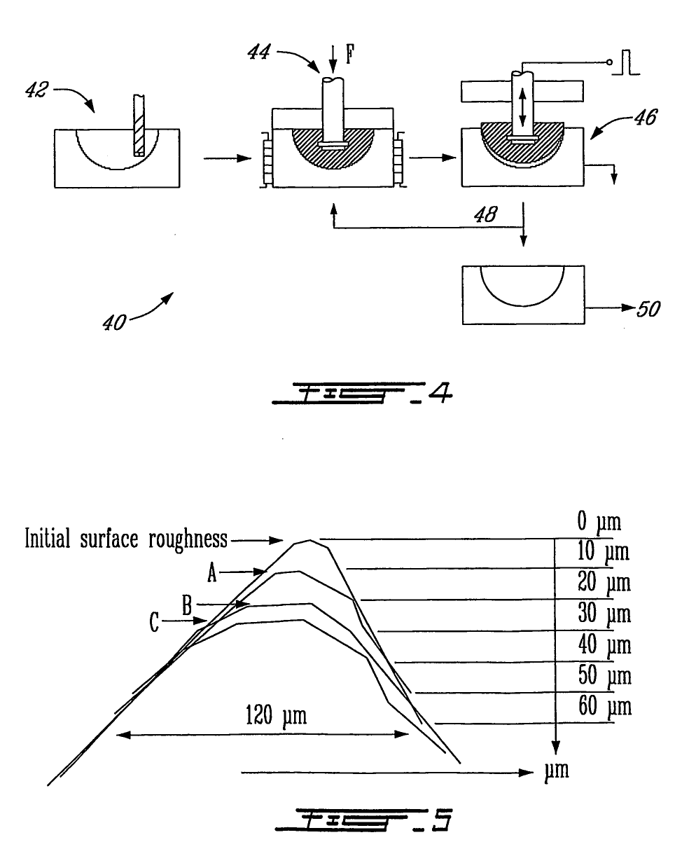

Turning now to FIG. 4 of the appended drawings, an EDM method according to a further embodiment of the second aspect of the present invention will be described, referred hereinafter as “the successive imprints EDM method”.

As illustrated in FIG. 4, the successive imprints EDM method 40 generally comprises providing a milled metal cavity as a mold; (step 42); forming of a negative replicate of the cavity into an electrode (step 44); and EDM finishing (step 46) to yield a finished cavity (step 50).

In step 42, a milled metal cavity that needs additional grinding or polishing to comply with injection molding requirements for example may be used. Such a pre-milled cavity is used as a mold to produce, by compression molding (step 44), a negative replicate of the cavity onto a ductile electrode, including extremely small surface features.

The compression molding step 44 is generally carried as described hereinabove in relation to the replica EDM method, except that the mold replica and the workpiece are now the same part. Since thereby an electrode is provided that comprises micro-peeks and valleys patterns of the workpiece, the electrode represents a negative of the workpiece in such a way that the micro-groove valleys of the workpiece become micro-peeks of the electrode and are used to level the workpiece surface.

Once molded, the electrode is shifted vertically, by a pre-determined offset distance, and used to eliminate, by spark erosion, the workpiece surface roughness (step 46).

Once a prescribed fraction of the cavity surface roughness is flattened and a new, smoother, workpiece surface is obtained, the electrode is reprocessed (step 48) through the compression molding step 44 described hereinabove in order to match the surface thereof with the new, smoother, workpiece surface. In such an iterative process, the surface roughness peeks of the workpiece are progressively flattened while the surface roughness valleys of the electrode are correspondingly filled up, so that, after each iteration, the surface of both the electrode and the workpiece are smoother, until a desired surface finish is achieved (step 50).

More specifically, the successive imprints EDM method may be performed by positioning the electrode at an initial pressing position on the workpiece including an additional small offset displacement perpendicular to marks or microgrooves left by the end mill, so that the motion of the electrode causes wear on all the workpiece surface peeks. The procedure may be repeated until the electrode has shifted for an entire width of a full peek. Once the peeks are removed, the same procedure may be repeated with a smaller offset displacement in order to polish the workpiece surface.

A mirror finish may be achieved (step 50) by adjusting the EDM control parameters of step 46 according to a remaining average surface peek height. The number of iterations 48 depends on parameters such as the workpiece material, the EDM parameters, the initial surface roughness and the desired surface finish.

From the foregoing, it should now appear that successive imprints of a cavity are used to iteratively refine a surface finish thereof, by flattening micro-peeks down to micro-valley created on the workpiece surface by a finishing ball end mill or turning tool. Since the bottom of the micro-valleys coincides with a desired dimension of the workpiece, a workpiece with a precise smooth surface is thus created.

Therefore, much like two identical pieces of material are polished by simply rubbing them against each other, successive imprints of a cavity are used to flatten surface roughness by spark energy. In the present method, since, following a minimum energy principle, sparks occur at a closest point between two surfaces subjected to a potential difference, the sparks occur between peeks of the electrode surface roughness and peeks of the cavity surface roughness, which coincide with a shortest achievable ionization delay or distance.

It is to be noted that the successive imprints EDM method may be even more effective by providing that the milling operation (taking place prior to step 42) follows a cutting path in such a way as to leave regularly spaced peek-valley surface structures along a desired surface line. Flat end mill or ball nose end mill may be used provided that a uniform surface structure is achieved.

People in the art will appreciate that the successive imprints EDM method may be used for finishing a conductive workpiece that has been milled or turned close to its final shape in a first stage, or for polishing such a workpiece for example.

Results obtained with the successive imprint EDM method will now be presented, in relation to FIG. 5, as a way of example.

An experiment is carried out, wherein first a tool steel surface with a well-known surface topology is produced. A saw tooth pattern with 177 μm amplitude and 354 μm period is milled out of a P20 tool steel material to generate an initial surface roughness. A single crest of the repetitive initial surface roughness is showed in the plot of FIG. 5 at 0 μm.

Then, the saw-tooth pattern is inserted into a mold in order to produce, by a compression molding process, a composite-polymer electrode with a matching surface pattern.

The electrode with the matching surface pattern is then shifted parallel to one of a surface crest edges such as to align peeks of the electrode surface with peeks of the tool steel surface.

A vertical gap distance between peeks is determined by EDM parameters used for the experiment and displayed in Table I below:

TABLE I

| | |
|---|---|
| Current impulse level | 1.5 A |
| Ton | 15 ps |
| Toff | 330 ps |
| Spark ignition voltage level | 150 V |
| Dielectric fluid | air (no flushing) |

The EDM process is performed for about 5 minutes, which corresponds approximately to a time yielding an undesirable wear level on the polymer electrode using the EDM parameters of Table I. After this EDM time, the tool steel material has also suffered a desirable 10 μm wear level as showed by the first EDM iteration (Curve A).

The same worn out tool steel material is then used over again as a surface texture template to produce a new modified composite-polymer electrode with a matching surface pattern. By following the method describe hereinabove, the new modified electrode is used to machine a second iteration (see Curve B) until it worn out. Then the same procedure is repeated for a third iteration (see Curve C).

The results illustrated in FIG. 5 are the combination of four different measurements taken on four random tool-steel surface peeks, made with a DEKTEK IIA, which has a vertical and an horizontal resolutions of 0.5 angstroms and 1 μm respectively. Clearly, the tool steel surface peek is gradually eroded by the controlled EDM iterative procedure.

It can be reasonably expected that, by carrying on the above process with further EDM iterations involving a gradually decreasing impulse energy, a desired surface finish can be obtained. Furthermore, people in the art will easily conceive that such a process may be fully automated since no additional process, such as solid graphite electrode machining for example, is required. As a result, the production cost of tool steel finishing operations can be significantly reduced.

Obviously, since in the present invention the electrode material is expected to wear slightly faster than conventional solid graphite electrode because of a higher polymer content thereof, the EDM control parameters have to be adjusted accordingly in order to achieve finish levels down to a mirror finish.

Unlike standard solid graphite or copper electrodes, the ductile polymer-carbon electrode of the present invention may be repeatedly softened and molded to a desired geometry with fine dimensional tolerance and surface finish, allowing the production of high quality molded electrodes with a much faster production rate than with known electrode fabrication methods.

Therefore, the EDM electrode and method of the present invention are expected to ease automation of finishing and polishing operations on metal parts as well as to provide a means to duplicate surface textures of random materials such as wood, fabrics, leather, etc., providing that a number of process parameters such as electrode composition, current impulse parameters, and water-based dielectric properties are optimized in order to reach the expected performance level.

It will now be evident that the present invention provides an improved electrode material leading to an improved EDM method allowing for a reduction of the production time and cost of precision metal parts.

Although the present invention has been described hereinabove by way of specific embodiments thereof, it can be modified without departing from the teachings of the subject invention, as defined in the appended claims.

What is claimed is:

1. An EDM electrode comprising a carbonaceous solid material and a matrix material, wherein said carbonaceous solid material has a content of carbon black of 35% wt or less.

2. The EDM electrode according to claim 1, further comprising a graphitized solid material.

3. The EDM electrode according to claim 2, wherein said graphitized solid material comprises a minimized proportion of a material selected in the group comprising graphite flakes, graphite whiskers and a maximized proportion of a material selected in the group comprising graphite powder and graphite nanotubes.

4. The EDM electrode according to claim 3, further comprising a metal powder in a proportion of 20% wt or less in replacement of a corresponding proportion of said graphitized solid material.

5. The EDM electrode according to claim 2, wherein said carbonaceous material and said graphitized material amount to a proportion included in the range between 40 and 75% by weight.

6. The EDM electrode according to claim 5, wherein said carbonaceous material comprises carbon black in the range between 5 and 20% wt.

7. The EDM electrode according to claim 3, wherein said a minimized proportion of graphite flakes is 20% wt or less; a minimized proportion of graphite whiskers is 5% wt or less; a maximized proportion of graphite powder is 50% wt or less; and a maximized proportion of graphite nanotubes is comprised between 1 and 10% wt.

8. The EDM electrode according to claim 1, wherein said matrix material comprises a matrix material selected in the group comprising thermoplastic polymer and wax.

9. The EDM electrode according to any of claims 1 to 8, wherein said EDM electrode is made by a method selected in the group comprising pressing, compression molding, blow molding and casting.

10. A method for fabricating an EDM electrode comprising the steps of:
providing a carbonaceous material; and
selecting a matrix material;
wherein said step of providing a carbonaceous material comprises providing graphite and carbon black with a proportion of carbon black of 35% wt or less.

11. The method according to claim 10, further comprising the step of providing a solid material depending on the matrix material selected, in the form of graphitized material.

12. The method according to claim 11, wherein said step of providing a solid material in the form of graphitized material comprises minimizing graphitized material selected in the group comprising flakes and whiskers, and maximizing graphitized material selected in the group comprising powder and nanotubes.

13. The method according to claim 11, wherein said step of providing a solid material comprises providing a solid material in a proportion included in the range between 40 and 75% by weight.

14. The method according to claim 13, wherein said step of providing a carbonaceous material comprises providing black carbon in a proportion included in the range between 5 and 20% by weight.

15. The method according to claim 12, wherein said minimizing graphitized flakes comprises providing graphite flakes in a proportion of 20% by weight or less; said minimizing graphitized whiskers comprises providing graphite whiskers in a proportion of 5% by weight or less; said maximizing graphitized powder comprises providing graphitized powder in a proportion of 50% by weight or less; and said maximizing graphitized nanotubes comprises providing graphitized nanotubes in a proportion between 1 and 10% by weight.

16. The method according to claim 10, wherein said step of selecting a matrix material comprises selecting a matrix material in the group comprising thermoplastic polymer and wax.

17. An EDM method for finishing a workpiece comprising the steps of:
providing a replica of the workpiece;
providing a generic electrode;
shaping the generic electrode into a matching electrode using the replica as a mold; and
performing EDM on the workpiece with the matching electrode.

18. The EDM method according to claim 17, wherein said step of providing a replica of the workpiece comprises selecting a template having a surface with a predetermined geometry selected in the group comprising a flat surface, a curved surface, a smooth surface and a textured surface.

19. The EDM method according to claim 18, wherein said step of providing a replica of the workpiece comprises providing a replica selected in the group comprising a single part mold and a plurality of interlocking mold parts.

20. The EDM method according to claim 18, wherein said step of providing a replica comprises providing a replica made in at least one good thermal conductor.

21. The EDM method according to claim 18, wherein said step of providing a generic electrode comprises providing an electrode of a geometric shape of desired dimensions selected in the group comprising a cylinder, a cone, a sphere, an ellipsoid and a cube.

22. The EDM method according to claim 18, wherein said step of providing a generic electrode comprises injection molding an electrode material around a metallic insert used as an electrode holder.

23. The EDM method according to claim 18, wherein said step of shaping the generic electrode into a matching electrode comprises the substeps of:
softening a carbonaceous electrode material;
pressing the softened carbonaceous electrode material onto the replica;
whereby the carbonaceous electrode material cools down and solidifies by heat transfer, yielding in the matching electrode with a desired shape and surface finish.

24. The EDM method according to claim 23, wherein said substep of softening a carbonaceous electrode material is achieved using a method selected in the group comprising induction heating, conduction heating and radiant heating.

25. The EDM method according to claim 23, wherein said substep of pressing the softened carbonaceous electrode material is conducted in a way selected in the group comprising using a robot arm and using a CNC (Computer Numerical Control) machine-tool, to carve an electrode shape and surface by moving the softened electrode material relative to the replica along 3D trajectories.

26. The EDM method according to claim 23, wherein said substep of pressing the softened carbonaceous electrode material is performed by applying pressure inside a preheated hollow ductile electrode confined inside a multiple part mold, by forcing gas through a bored electrode holder insert onto which the hollow ductile electrode is affixed, so that the softened electrode material inflates under the gas pressure until conforming to a shape and surface finish of a part of the multiple part mold, then cooling down and solidifying into a desired shape.

27. The EDM method according to claim 18, wherein said performing EDM is done in a way selected in the group comprising simple plunging, orbital plunging and stylus machining.

28. The EDM method according to claim 18, wherein said performing EDM comprises using a dielectric fluid selected in the group comprising deionized water, mineral oil and gas.

29. The EDM method according to claim 28, wherein said gas is air.

30. The EDM method according to claim 18, wherein said step of performing EDM comprises adjusting electrical impulse parameters to minimize a wear of the electrode.

31. The EDM method for finishing operations on a workpiece comprising the steps of:
providing a replica of the workpiece; and
molding a ductile electrode in the replica of the workpiece.

32. The EDM method according to claim 31, wherein said step of providing a replica of the workpiece comprises providing a replica of a localized part of the workpiece by selecting a replica in a bank of geometric replicas comprising sharp edges, smooth fillets, geometries, surface textures, comers, deep grooves, 90° edges and 90° fillets with various radius.

33. The EDM method according to claim 31, wherein said step of molding a ductile electrode in the replica of the workpiece comprises the substeps of:
preheating the replica in the vicinity of a melting point temperature of a polymer matrix of the electrode;
feeding pellets of a composite material into the pre-heated replica;
closing the replica by means of a tight cover;
compressing the pellets of a composite material in the closed replica;
forming an electrode inside the replica;
cooling down the replica and allowing the electrode to solidify;
wherein said substep of forming a electrode inside the replica comprises creating an isostatic pressure inside the replica and maintaining the isostatic pressure to allow a uniform temperature distribution throughout the composite material herein and to yield an electrode having enhanced surface details and a minimum amount of porosity.

34. A method for reworking a ductile electrode used to EDM a workpiece, by forming the ductile electrode in a replica of the workpiece comprising the steps of:
preheating the replica in the vicinity of a melting point temperature of a polymer matrix of the ductile electrode;
feeding a single piece of material with roughly a same geometry as the replica into the pre-heated replica;
closing the replica by means of a tight cover;
compressing the content of the closed replica;
shaping the electrode inside the replica;
cooling down the replica and allowing the electrode to solidify;
wherein said step of shaping the electrode inside the replica comprises creating a isostatic pressure inside the replica and maintaining the isostatic pressure to allow a uniform temperature distribution throughout the polymer composite and to yield a reshaped electrode.

35. The method according to claim 34, wherein said method further comprises the step of preheating the ductile electrode to soften an outside surface thereof.

36. An EDM method for finishing operations a milled metal cavity comprising the steps of:
forming, in the milled metal cavity used as a mold, a negative replicate of the milled metal cavity into an electrode; and
EDM the milled metal cavity with the electrode;
whereby the electrode comprises micro-peeks and valleys patterns of the milled metal cavity, thus representing a negative of the milled metal cavity in such a way that the micro-groove valleys of the milled metal cavity become micro-peeks of the electrode and are used to level the milled metal cavity surface by spark erosion.

37. An EDM method for finishing operation on a milled metal cavity using the pre-milled cavity as a mold to form a negative replicate of the cavity onto a ductile electrode that results as a negative of the milled metal cavity so that micro-groove valleys of the milled metal cavity become micro-peeks of the electrode that level the milled metal cavity surface by spark erosion and, once a prescribed fraction of the cavity surface roughness is flattened and a new, smoother, cavity surface is obtained, the electrode is reprocessed in the new, smoother, cavity in order to match the surface thereof with the new, smoother, cavity surface.

38. A method for molding a composite carbonaceous material into a generic electrode of simple geometric shape held around a metallic insert holder wherein a ductile electrode material is softened to yield a softened electrode, which is then pressed against a mold in order to be given a final shape and surface finish.

39. The method recited in 38, wherein the ductile electrode material is softened by a method selected in the group comprising induction heating, radiant heating and conduction heating.

40. The method recited in 38, wherein the softened electrode is pressed against an original of a part of a workpiece in order to extract a negative geometry thereof, which can be used to duplicate an original geometry of said part.

41. The method recited in 38, wherein the softened electrode is carved by a relative movement between the softened electrode and the mold, following 3D trajectories.

42. The method recited in 38, wherein the softened electrode is pressed by inflating a hollow electrode, held by a bored metallic insert, inside a multiple parts mold which temperature can be controlled by cooling passages.

43. A use of a ductile carbonaceous-metal polymer composite material as an EDM electrode to perform electric discharge machining of electrically conductive material.

44. The use of a ductile carbonaceous-metal polymer composite material as an EDM electrode according to claim 43, wherein the electrode is used until it wears out and wherein the electrode is reworked to an initial shape.

45. A method for finishing and polishing a workpiece using a ductile electrode material, by following a pressing method where the ductile electrode is a replica of the workpiece or of a part of the workpiece that is used to remove micro-peeks by EDM machining, by shifting the electrode from an initial molding position thereof over a width of the micro-peeks.
